(19) United States
(12) Patent Application Publication
(10) Pub. No.: US 2025/0037350 A1
(43) Pub. Date: Jan. 30, 2025

(54) INFORMATION PROCESSING APPARATUS, CONTROL METHOD FOR INFORMATION PROCESSING APPARATUS, AND STORAGE MEDIUM

(71) Applicant: CANON KABUSHIKI KAISHA, Tokyo (JP)

(72) Inventor: DAICHI ADACHI, Tokyo (JP)

(21) Appl. No.: 18/785,911

(22) Filed: Jul. 26, 2024

(30) Foreign Application Priority Data
Jul. 27, 2023 (JP) 2023-122743

(51) Int. Cl. G06T 15/10; G06T 7/73; G06T 15/08; G06T 17/10

(52) U.S. Cl. CPC G06T 15/10; G06T 7/73; G06T 15/08; G06T 17/10; G06T 2207/20081

(57) ABSTRACT

An information processing apparatus comprising: one or more memories storing instructions; and one or more processors executing the instructions to: obtain a first virtual viewpoint image, wherein the first virtual viewpoint image is generated based on a group of images obtained by shooting a subject from a plurality of directions; obtain at least one image coordinate in a specific region in the first virtual viewpoint image; determine, based on a pixel value at the at least one image coordinate, a parameter for generating a virtual viewpoint image; and generate a second virtual viewpoint image using the determined parameter.

### BACKGROUND

### Field of the Disclosure

The present disclosure relates to an information processing apparatus, a control method for the information processing apparatus, and a storage medium.

### Description of the Related Art

In recent years, attention has been drawn to volumetric techniques in which a plurality of shooting apparatuses are installed at different positions and perform synchronized shooting, and a virtual viewpoint image is generated by compositing a plurality of images based on this shooting. With conventional volumetric techniques, a virtual viewpoint image may include unnatural colors due to differences in the generated shape of a subject, noise in the images shot by the respective shooting apparatuses, and the like.

It is disclosed in Japanese Patent Laid-Open No. 2019-106617 that the images used in the composition for such a virtual viewpoint image are displayed in descending order of the contribution percentage.

However, according to the technique described in Japanese Patent Laid-Open No. 2019-106617, a user needs to find an image that causes noise by searching a plurality of displayed images, and it is also necessary to take a measure to cancel the noise by, for example, invalidating this image. Thus, there has been a problem that a task is complex, and a waste occurs because image data outside the noise becomes invalid, for example.

### SUMMARY

The present disclosure has been made in view of the aforementioned problem, and provides a technique to alleviate the complexity of the search for an image that causes noise, and also to generate a virtual viewpoint image by effectively using image data outside a noise region.

According to one aspect of the present disclosure, there is provided an information processing apparatus comprising: one or more memories storing instructions; and one or more processors executing the instructions to: obtain a first virtual viewpoint image, wherein the first virtual viewpoint image is generated based on a group of images obtained by shooting a subject from a plurality of directions; obtain at least one image coordinate in a specific region in the first virtual viewpoint image; determine, based on a pixel value at the at least one image coordinate, a parameter for generating a virtual viewpoint image; and generate a second virtual viewpoint image using the determined parameter.

Further features of the present disclosure will become apparent from the following description of exemplary embodiments with reference to the attached drawings.

### BRIEF DESCRIPTION OF THE DRAWINGS

FIG. 1 shows a system configuration diagram according to one or more aspects of the present disclosure.

FIG. 2 shows a schematic diagram of a space in which shooting is performed according to one or more aspects of the present disclosure.

FIG. 3 shows a hardware configuration diagram of an information processing apparatus according to one or more aspects of the present disclosure.

FIG. 4 is a flowchart showing a procedure of processing executed by the information processing apparatus according to one or more aspects of the present disclosure.

FIG. 5 shows a UI screen displayed on a display apparatus according to one or more aspects of the present disclosure.

FIG. 6 shows a processing result displayed on the display apparatus according to one or more aspects of the present disclosure.

FIG. 7 shows a UI screen displayed on the display apparatus according to one or more aspects of the present disclosure.

FIG. 8 shows a processing result displayed on the display apparatus according to one or more aspects of the present disclosure.

FIG. 9 shows a system configuration diagram according to one or more aspects of the present disclosure.

FIG. 10 is a flowchart showing a procedure of processing executed by the information processing apparatus according to one or more aspects of the present disclosure.

FIG. 11 shows a UI screen displayed on the display apparatus according to one or more aspects of the present disclosure.

FIG. 12 shows a processing result displayed on the display apparatus according to one or more aspects of the present disclosure.

FIG. 13 shows a system configuration diagram according to one or more aspects of the present disclosure.

FIG. 14 is a flowchart showing a procedure of processing executed by the information processing apparatus according to one or more aspects of the present disclosure.

FIG. 15A shows an image input to a training model according to one or more aspects of the present disclosure.

FIG. 15B shows an inference result image of the training model according to one or more aspects of the present disclosure.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to an disclosure that requires all such features, and multiple such features may be combined as appropriate. Furthermore, in the attached drawings, the same reference numerals are given to the same or similar configurations, and redundant description thereof is omitted.

### First Embodiment

The present embodiment will be described using an example that, in a system that generates a virtual viewpoint image based on images obtained by shooting a subject from a plurality of directions, generates a virtual viewpoint image from which noise has been removed based on pixel values of noise in a region designated by a user.

Note that images described in the present embodiment are not limited to still images, and the description will be provided under the assumption that the images also include a video that is shot or reproduced over a period of continuous times.

### <System Configuration>

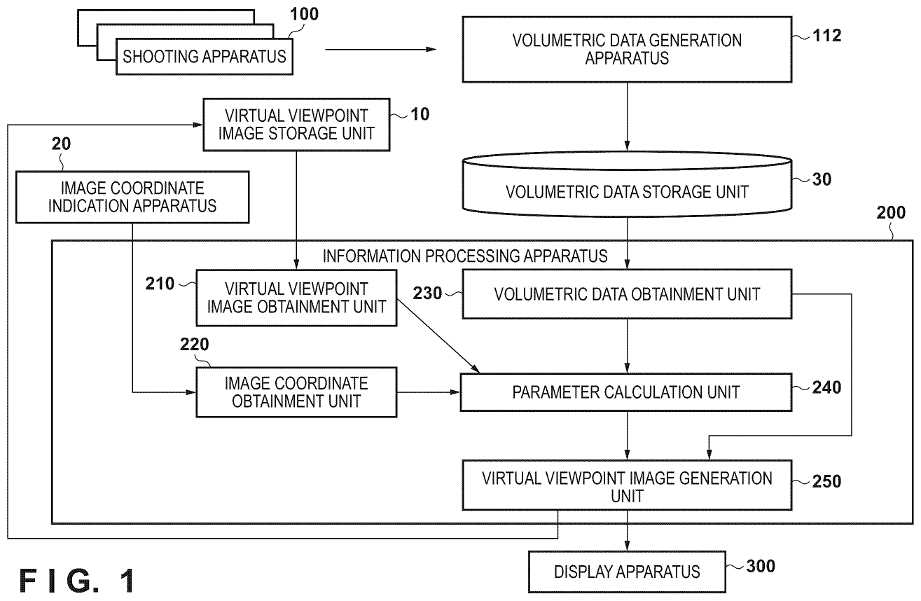

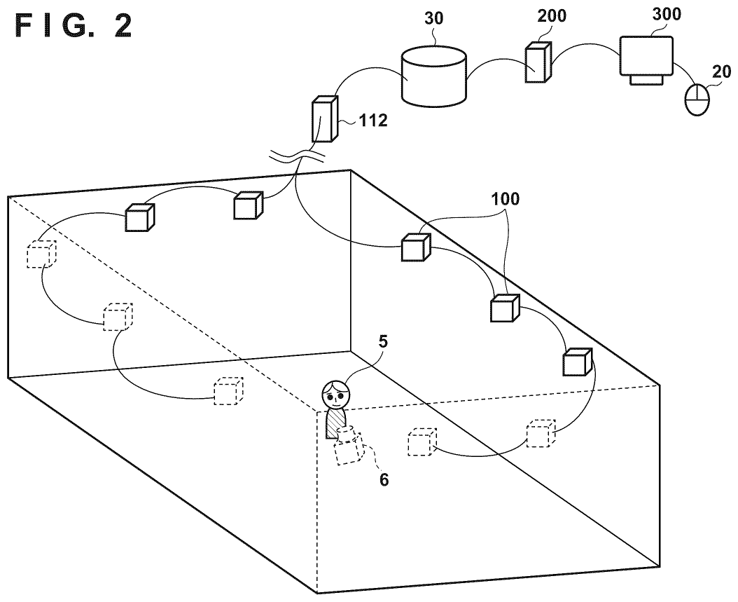

FIG. 1 shows a system configuration diagram according to a first embodiment. A plurality of shooting apparatuses 100 shoot a shooting area from a plurality of directions. The shooting area is, for example, an indoor shooting studio, a stage where a play is performed, or the like. FIG. 2 shows a schematic diagram of a space where shooting is performed. The plurality of shooting apparatuses 100 are fixedly installed at different positions so as to, for example, surround the shooting area, and perform shooting in synchronization with one another.

Note that the plurality of shooting apparatuses 100 may not be installed across the entire periphery of the shooting area, or may be installed to face the shooting area only in a partial direction depending on, for example, restrictions on installation positions. Also, the number of shooting apparatuses is not limited to the examples shown in FIG. 1 and FIG. 2; for example, in a case where the shooting area is a soccer stadium, a plurality of shooting apparatuses may be installed around the stadium. Furthermore, shooting apparatuses with different functions, such as telephoto cameras and wide-angle cameras, may be installed.

As shown in FIG. 2, the shooting apparatuses 100 are connected to one another in the form of cascade connection using wired communication cables, and ends of the cables are bundled via a switching hub or the like and connected to a volumetric data generation apparatus 112. The connection method is not limited to this; transmission may be performed wirelessly, or a star-connection configuration in which each of the shooting apparatuses 100 is connected directly to the volumetric data generation apparatus 112 may be adopted.

The volumetric data generation apparatus 112 obtains images from the shooting apparatuses 100, generates shooting apparatus information using the obtained images, and stores the shooting apparatus information into a volumetric data storage unit 30. Here, the shooting apparatus information is a set of parameters including the three-dimensional positions of the plurality of shooting apparatuses 100, the directions of the shooting apparatuses in panning, tilting, and rolling directions, and the field-of-view sizes (angles of view) and resolutions of the shooting apparatuses. The shooting apparatus information is calculated in advance in a procedure of known camera calibration. That is to say, a marker is shot simultaneously by the plurality of shooting apparatuses 100, the image coordinates at which the marker has been detected in a plurality of images obtained through the shooting are mutually associated, and the shooting apparatus information is calculated through geometric calculation.

Note that the contents of the shooting apparatus information are not limited to the ones described above. The shooting apparatus information may include a plurality of parameter sets. For example, the shooting apparatus information may be information which includes a plurality of parameter sets that respectively correspond to a plurality of frames composing moving images of the shooting apparatuses, and which indicates the positions and directions of the shooting apparatuses at each of a plurality of continuous time points.

Also, the method of generating volumetric data in the volumetric data generation apparatus 112 is not limited in particular. For example, shape data of a subject 5 may be generated using a volume intersection method described in Japanese Patent Laid-Open No. 2019-106617, and stored into the volumetric data storage unit 30 as volumetric data. Furthermore, the volumetric data storage unit 30 may include a group of images shot by the shooting apparatuses 100.

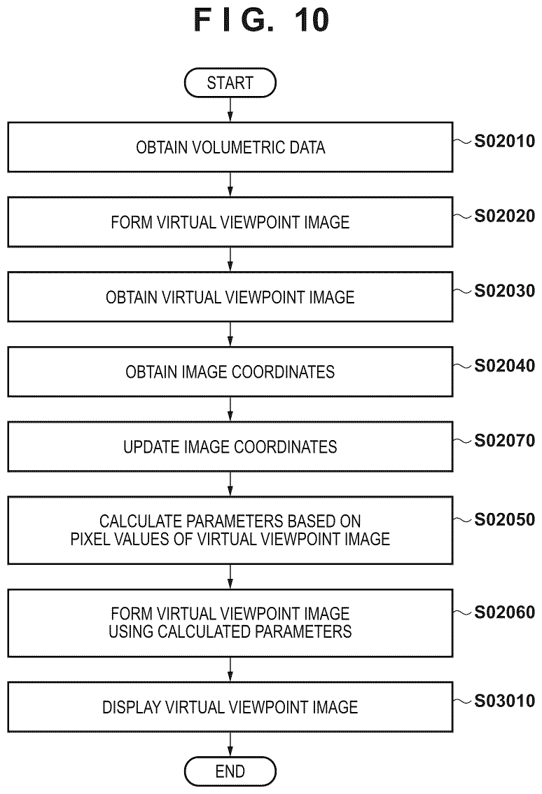

An information processing apparatus 200 obtains virtual viewpoint image data from a virtual viewpoint image storage unit 10, and obtains image coordinate data from an image coordinate indication apparatus 20. Furthermore, the information processing apparatus 200 obtains volumetric data from the volumetric data storage unit 30. Then, the information processing apparatus 200 updates the virtual viewpoint image data, and also displays a virtual viewpoint image on a display apparatus 300. Here, the virtual viewpoint image data is generated by the information processing apparatus 200 in advance as indicated by step S02020, which will be described later with reference to FIG. 10.

The image coordinate indication apparatus 20 is, for example, a mouse, and transmits image coordinate data of a position which has been indicated by a pointer and at which the mouse has been clicked on a later-described operation screen as, for example, integer values along the x- and y-axes that are perpendicular to each other with the lower-left corner of the screen acting as the origin. Alternatively, it may be, for example, a touch panel or the like. The display apparatus 300 is a device such as a liquid crystal display and a tablet terminal, and displays data of the received virtual viewpoint image on a screen.

### <Functional Configuration of Information Processing Apparatus>

The information processing apparatus 200 includes a virtual viewpoint image obtainment unit 210, an image coordinate obtainment unit 220, a volumetric data obtainment unit 230, a parameter calculation unit 240, and a virtual viewpoint image generation unit 250.

The virtual viewpoint image obtainment unit 210 obtains, for example, virtual viewpoint image data in a 3-channel RGB format with a full high-definition (HD) resolution. A virtual viewpoint image is not limited to being in this data format, and may have a 4K resolution, be in a 4-channel RGBA format, or be a grayscale image, for example. Furthermore, a virtual viewpoint image may be in a format where it is represented by luminance and a color difference.

The image coordinate obtainment unit 220 obtains image coordinate data indicated by the image coordinate indication apparatus 20 as integer values of x and y. The volumetric data obtainment unit 230 obtains volumetric data from the volumetric data storage unit 30.

The parameter calculation unit 240 calculates virtual viewpoint image generation parameters to be used in the virtual viewpoint image generation unit 250 with use of the obtained virtual viewpoint image, image coordinates, volumetric data, and virtual viewpoint information. The details of these virtual viewpoint image generation parameters will be described later.

It is assumed that, in the initial state, a virtual viewpoint is defined by a virtual camera 6 that is virtually arranged at a position looking up the subject 5 shown in FIG. 2 from below. This is because, in general, an underfloor camera cannot be installed, and noise easily occurs therewith. However, the initial state is not limited to this. Furthermore, the virtual viewpoint information is data of the three-dimensional position, the angle of view, and the like of the virtual viewpoint described in a format similar to the format of the shooting apparatus information, and is held in a non-illustrated storage unit by reading in a data file indicating the virtual viewpoint information in advance.

Note that in a case where the image coordinates have not been indicated and obtained, the virtual viewpoint image generation parameters may be calculated using a method described in Japanese Patent Laid-Open No. 2018-42237. The “virtual viewpoint image generation parameters” according to the present embodiment are equivalent to “weights” described in Japanese Patent Laid-Open No. 2018-42237.

The virtual viewpoint image generation unit 250 generates a virtual viewpoint image based on an image blending technique described in Japanese Patent Laid-Open No. 2018-42237 with use of the volumetric data, the virtual viewpoint information, and the virtual viewpoint image generation parameters calculated by the parameter calculation unit 240. That is to say, with respect to each pixel in the virtual viewpoint image, the group of images of the respective shooting apparatuses 100 are associated based on the shape of the subject, and the color thereof is calculated through blending based on the virtual viewpoint image generation parameters.

The virtual viewpoint image generated here is turned into data in the same data format as the virtual viewpoint image data in the virtual viewpoint image storage unit 10. Then, the virtual viewpoint image data in the virtual viewpoint image storage unit 10 is updated, and is also transmitted to the display apparatus 300.

### <Hardware Configuration of Information Processing Apparatus>

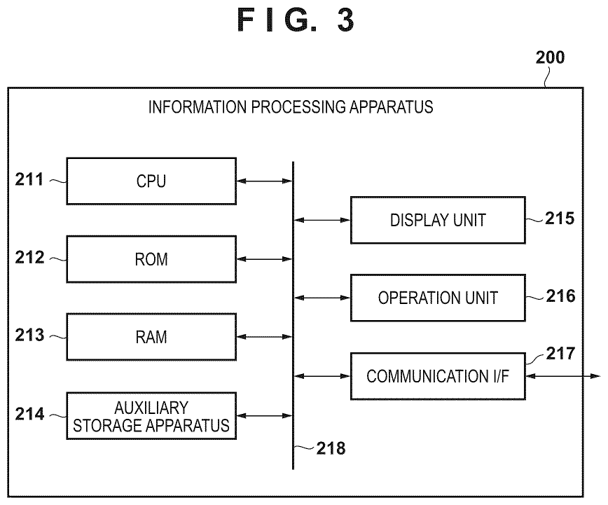

Next, FIG. 3 shows a hardware configuration diagram of the information processing apparatus 200 according to the present embodiment. Note that the hardware configurations of the volumetric data generation apparatus 112 and the display apparatus 300 are also similar to the configuration of the information processing apparatus 200 described below.

The information processing apparatus 200 includes a CPU 211, a ROM 212, a RAM 213, an auxiliary storage apparatus 214, a display unit 215, an operation unit 216, a communication I/F 217, and a bus 218. The CPU 211 realizes each function of the information processing apparatus 200 shown in FIG. 1 by controlling the entirety of the information processing apparatus 200 using a computer program and data stored in the ROM 212 and the RAM 213.

Note that the information processing apparatus 200 may include one or more items of dedicated hardware different from the CPU 211, and at least a part of processing executed by the CPU 211 may be executed by the item(s) of dedicated hardware. Examples of dedicated hardware include an application-specific integrated circuit (ASIC), a field-programmable gate array (FPGA), a digital signal processor (DSP), and the like.

The ROM 212 stores, for example, a program that need not be changed. The RAM 213 temporarily stores a program and data supplied from the auxiliary storage apparatus 214, data supplied from the outside via the communication I/F 217, and the like. The auxiliary storage apparatus 214 is composed of, for example, a hard disk drive or the like, and stores various types of data such as image data and sound data. The display unit 215 is composed of, for example, a liquid crystal display, an LED, or the like, and displays, for example, a graphical user interface (GUI) that is intended for a user to operate the information processing apparatus 200. The operation unit 216 is composed of, for example, a keyboard, a mouse, a joystick, a touch panel, or the like, and inputs various types of instructions to the CPU 211 upon receiving a user operation. The CPU 211 operates as a display control unit that controls the display unit 215, and an operation control unit that controls the operation unit 216.

The communication I/F 217 is used in communication with an apparatus that is outside the information processing apparatus 200. For example, in a case where the information processing apparatus 200 is connected to an external apparatus by wire, a cable for communication is connected to the communication I/F 217. In a case where the information processing apparatus 200 has a function of performing wireless communication with an external apparatus, the communication I/F 217 includes an antenna. The bus 218 transmits information by connecting the discrete components of the information processing apparatus 200 to one another. Although it is assumed in the present embodiment that the display unit 215 and the operation unit 216 are present inside the information processing apparatus 200, at least one of the display unit 215 and the operation unit 216 may be present outside the information processing apparatus 200 as another apparatus.

### <Processing>

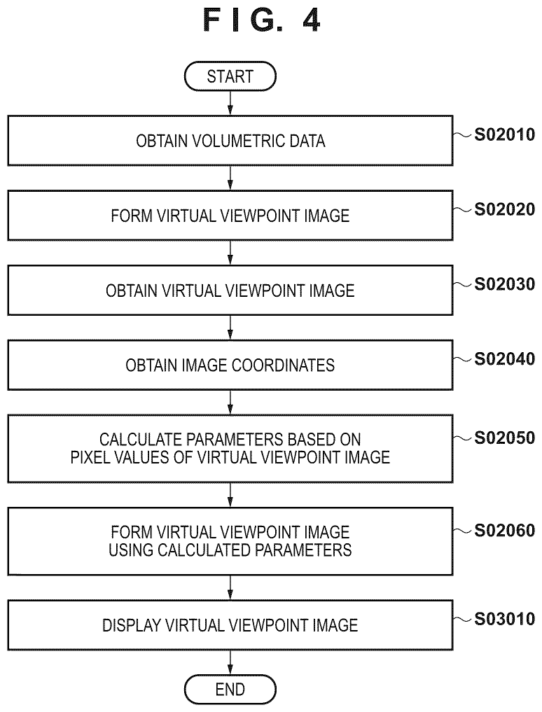

Next, a procedure of processing executed by the information processing apparatus 200 according to the present embodiment will be described with reference to a flowchart of FIG. 4. In step S02010, the volumetric data obtainment unit 230 obtains volumetric data from the volumetric data storage unit 30.

In step S02020, the information processing apparatus 200 reads out predetermined virtual viewpoint information from a non-illustrated storage apparatus in a state where image coordinates have not been indicated. Then, it calculates virtual viewpoint image generation parameters based on formula (2)-1, which will be described later, and generates a virtual viewpoint image. The generated virtual viewpoint image is displayed on the display apparatus 300. In step S02030, the virtual viewpoint image obtainment unit 210 obtains virtual viewpoint image data from the virtual viewpoint image storage unit 10.

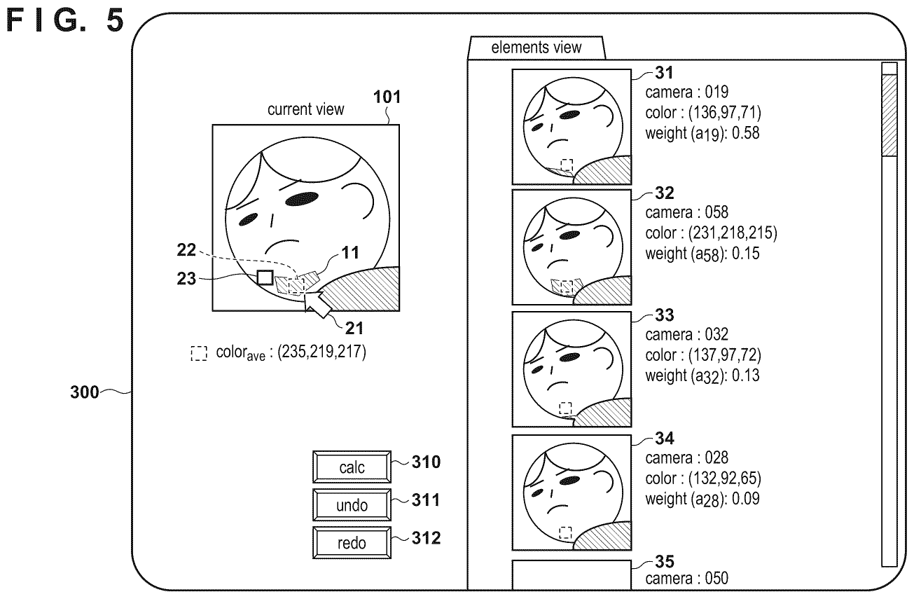

Then, using the image coordinate indication apparatus 20, a user indicates image coordinates in a specific region (noise region) while viewing the virtual viewpoint image via the display apparatus 300. FIG. 5 shows an example of a UI screen that is displayed on the display apparatus 300 for indicating image coordinates according to the present embodiment. While referring to the virtual viewpoint image, the user clicks on image coordinates 22 in a noise region 11 at a position of a mouse pointer 21 that moves in accordance with maneuvering of the image coordinate indication apparatus 20, that is to say, mouse. The image coordinates 22 are image coordinates in the noise region that have been indicated by the user. Note that the image coordinates 22 may be one point (one pixel), or may be a pixel group including a plurality of pixels. As a result, the image coordinates are input, and image coordinate data is transmitted from the image coordinate indication apparatus 20.

In step S02040, the image coordinate obtainment unit 220 receives the image coordinate data transmitted from the image coordinate indication apparatus 20. The received image coordinates 22 are presented to the user via the display apparatus 300. The designated image coordinates may indicate not only one point, but also a plurality of arbitrary regions that can be input by maneuvering the mouse. Alternatively, a plurality of sets of coordinates may be collectively designated as a quadrilateral region. In the present embodiment, it is assumed that a quadrilateral region of 5×5 pixels has been designated. Note that the size of the quadrilateral region is not limited to this example.

In step S02050, in response to pressing of a “calc” button 310 on the UI screen by the user, the image coordinate parameter calculation unit 240 starts to calculate virtual viewpoint image generation parameters based on the image coordinate data received in step S02040.

In a system that generates a virtual viewpoint image using volumetric data, pixel values in the virtual viewpoint image are calculated by compositing a group of images shot by the plurality of shooting apparatuses 100. A virtual viewpoint image generation parameter according to the present embodiment is a coefficient by which a pixel value of each element included in the image group is multiplied. That is to say, a pixel value [Ro, Go, Bo] at a pixel position [x, y] in the virtual viewpoint image is calculated using the following formula (1).

$$[ Math . 1 ]$$

$$I ( x , y ) = [ \begin{matrix}{R}_{o} \\ {G}_{o} \\ {B}_{o}\end{matrix} ] = \frac{{\sum }_{n = 1}^{{N}_{c a m}} {a}_{n} {I}_{n} ( x , y )}{{N}_{cam}} = \frac{{\sum }_{n = 1}^{{N}_{can}} {a}_{n} [ \begin{matrix}{R}_{n} \\ {G}_{n} \\ {B}_{n}\end{matrix} ]}{{N}_{cam}} \qquad ( 1 )$$

Here, I (x, y) and Iₙ (x, y) denote pixel values at the pixel position x, y received in step S02040 in the virtual viewpoint image and each element included in the image group, respectively. Also, N_{cam} denotes the number of the shooting apparatuses 100, and an denotes a coefficient, namely a virtual viewpoint image generation parameter. Furthermore, an image Iₙ is an image calculated by projecting pixels on shape data of the subject 5 using only the n^{th} image included in the image group; as indicated by 31 to 35 in FIG. 5, images Iₙ are shown in descending order of the value of the virtual viewpoint image generation parameter aₙ. Note that other elements can be referred to by scrolling the screen.

In the present step, a virtual viewpoint image generation parameter an is calculated using the following formulae (2) in accordance with a degree of similarity between I and Iₙ.

$$[ Math . 2 ]$$

$${a}_{n} ( x , y ) = \{ \begin{matrix}f ( θ , dist ) & if pt ( x , y ) not exists & ( 2 ) - 1 \\ 0.1 ⋆ {a}_{n} & else if Δ E ( I , {I}_{n} ) < {th}_{Δ E} & ( 2 ) - 2 \\ {a}_{n} & else if Δ E ( I , {I}_{n} ) < {th}_{Δ E} & ( 2 ) - 3\end{matrix}$$

In a case where the image coordinates have not been indicated, the virtual viewpoint image generation parameter an is calculated using formula (2)-1 based on a function f (θ, dist) as described in Japanese Patent Laid-Open No. 2018-42237. Here, θ denotes an angle formed by a three-dimensional vector extending from the virtual viewpoint to the pixel (x, y) and a three-dimensional vector extending from the n^{th} shooting apparatus 100 to the subject 5.

Also, dist denotes a distance from the image coordinates which are in each image included in the image group and which are obtained by shooting a point on a three-dimensional model projected on the pixel x, y in the virtual viewpoint image to an edge of the image. The function f is designed so that the value thereof increases as θ decreases, that is to say, as the angle formed by the virtual viewpoint and the shooting apparatus decreases. Furthermore, the function f is designed so that the value thereof decreases as the distance dist decreases. Note that the function f is not limited to being designed in the foregoing manner. ΔE is a function indicating a color difference between I and Iₙ, and is calculated as a Euclidean distance in the RGB space with use of formula (3).

$$[ Math . 3 ]$$

$$Δ E = \sqrt{{( {R}_{o} - {R}_{n} )}^{2} + {( {G}_{o} - {G}_{n} )}^{2} + {( {B}_{o} - {B}_{n} )}^{2}} \qquad ( 3 )$$

Note that ΔE is not limited to being designed in the foregoing manner; for example, a color difference calculation formula such as delta E76 may be used instead. In a case where ΔE is smaller than a threshold thΔE, the target is deemed as an outlier that has a color similar to the noise region, and the value of the virtual viewpoint image generation parameter an is reduced (multiplied by 0.1) using formula (2)-2. Otherwise, the target is deemed as an inlier that has a normal color and the value of the virtual viewpoint image generation parameter an is returned as is using formula (2)-3.

Regarding the image coordinates 22, as they have been indicated as the noise region to be removed, the value of the virtual viewpoint image generation parameter an that has been calculated in advance in step S02020 is reduced by multiplying the same by 0.1 using formula (2)-2. The foregoing processing is executed with respect to every set of image coordinates 22, and the virtual viewpoint image generation parameter an is calculated and updated for each set.

As described above, in a case a degree of similarity between a pixel value in a specific region (noise region) of the virtual viewpoint image and a pixel value in the group of images of the respective shooting apparatuses 100 that contributes to determination of such a pixel value is equal to or higher than a threshold (the difference therebetween is equal to or smaller than a threshold), the virtual viewpoint image generation parameter an is calculated using formula (2)-2 so that the extent of contribution becomes small compared to the opposite case. Alternatively, the virtual viewpoint image generation parameter aₙ may be calculated so that the extent of contribution decreases as the degree of similarity increases.

Furthermore, inliers and outliers may be determined using a clustering method such as k-means clustering in the color space, in place of the method of determining inliers and outliers using color differences and a threshold. Moreover, a weight, namely a coefficient may be calculated in addition to the execution of removal of outliers using a robust estimation method such as M-estimation.

In step S02060, the virtual viewpoint image generation unit 250 obtains the volumetric data and the virtual viewpoint image generation parameters an, and calculates pixel values in the virtual viewpoint image in accordance with formula (1). Note that in order to reduce a waste in processing, for example, only the pixel at the image coordinates 22 may be calculated, and pixel values may be updated.

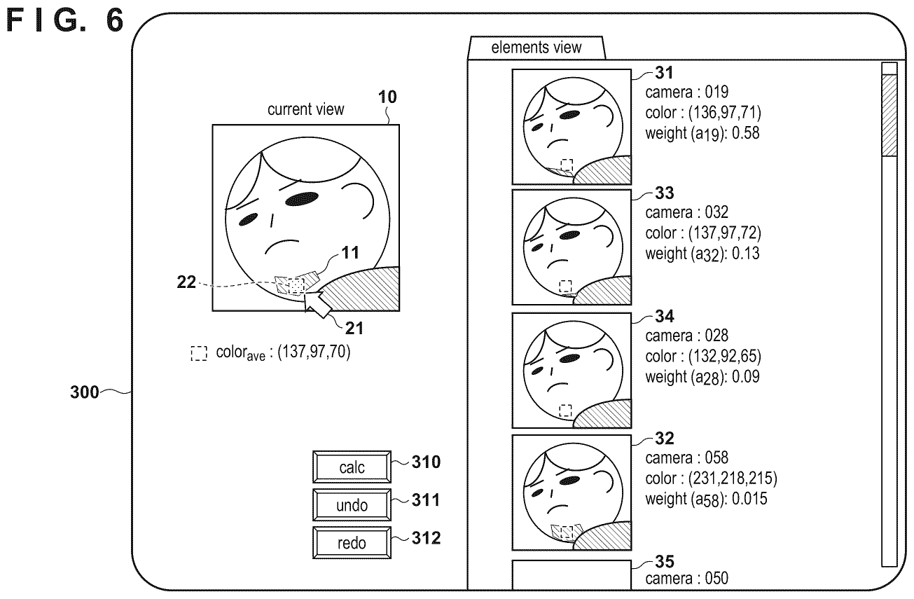

In step S03010, the virtual viewpoint image generation unit 250 outputs the virtual viewpoint image to the display apparatus 300, and the display apparatus 300 updates and displays the virtual viewpoint image 101 on the UI screen. The updated and displayed UI screen is shown in FIG. 6. The value of the weight (a58) corresponding to a pixel value of noise included in the camera: 058 has been reduced, and its coefficient has become small. As a result, the value of the average pixel value color_ave in the quadrilateral region at the image coordinates 22 has been improved, and noise 11 has been alleviated.

The foregoing steps may be repeatedly executed multiple times while the user is checking. Furthermore, it is permissible to place an undo button 311 and a redo button 312 on the UI screen, and provide a function of, for example, reading in past cache data held in the RAM 213 and restoring the virtual viewpoint image 101 to the immediately preceding state in response to pressing of these buttons.

As described above, based on a pixel value of noise in a region designated by the user, the virtual viewpoint image generation parameters are calculated so as to reduce the coefficients of elements that have contributed to the determination of such a pixel value, and the virtual viewpoint image is updated; in this way, the influence of noise can be reduced.

Therefore, the complexity of the search for an image that causes noise can be reduced, and in addition, the virtual viewpoint image can be generated by effectively using image data outside the noise region.

### Exemplary Modification of First Embodiment

The first embodiment has been described using an example in which a noise region is designated, and the influence of noise is reduced by reducing the coefficients of elements that have pixel values similar to a pixel value of the noise region. The present exemplary modification will be described using an example in which an expected pixel value is further designated as opposed to a noise region, and control is performed to become close to the expected pixel value by increasing the coefficients of elements that have pixel values similar to this expected pixel value. A description of constituents similar to those of the first embodiment will be omitted.

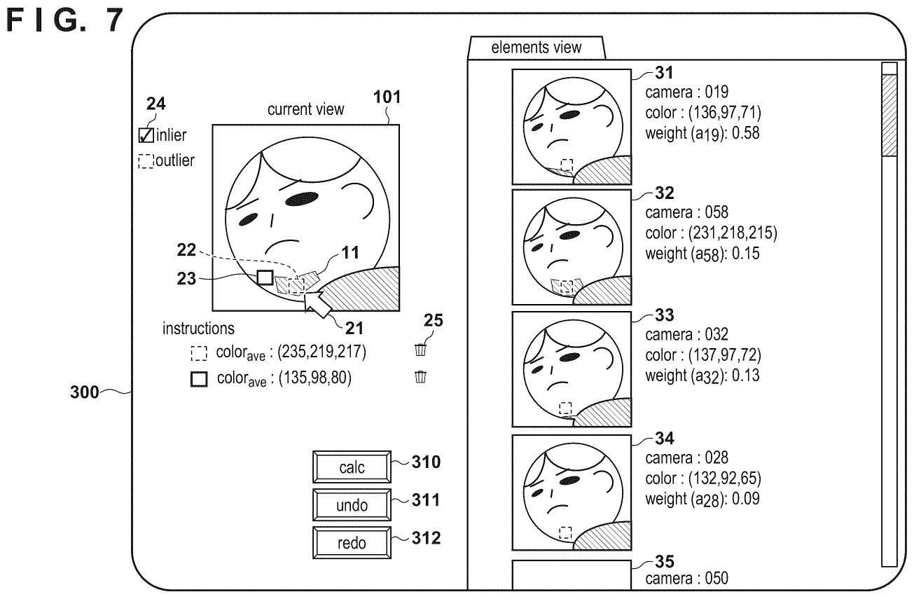

FIG. 7 shows a UI screen displayed on the display apparatus 300 in step S02040 of FIG. 4 in the case of the present exemplary modification. The user selects a type of indication (inlier or outlier) via a checkbox 24, and then inputs an inlier region 23 that has an expected pixel value and/or an outlier region 22 to be removed as a noise region by clicking the mouse. The input indications are displayed as a list. An unnecessary indication can be deleted by clicking a discard icon 25. When the “calc” button 310 has been pressed after the indications have been input, parameter calculation processing is started. At this time, the virtual viewpoint image generation parameters an are calculated using formulae (2) with respect to the image coordinates x, y of the outlier region 22, and then further updated using the following formulae (4).

$$[ Math . 4 ]$$

$${a}_{n} ( x , y ) = \{ \begin{matrix}{a}_{n} & if pt ( x , y ) not exists & ( 4 ) - 1 \\ 0.1 ⋆ {a}_{n} & else if Δ E ( I ( {x}_{inl} , {y}_{inl} ) , {I}_{n} ) > {th}_{Δ E} & ( 4 ) - 2 \\ 1.5 ⋆ {a}_{n} & else if Δ E ( I ( {x}_{inl} , {y}_{inl} ) , {I}_{n} ) \leq {th}_{Δ E} & ( 4 ) - 3\end{matrix}$$

Here, I (xin1, yin1) denotes a representative value of pixel values of the virtual viewpoint image 101 at a plurality of sets of image coordinates (xin1, yin1) in the inlier region 23. If the value is close to this representative value, the value of the virtual viewpoint image generation parameter an is increased (multiplied by 1.5) using formula (4)-3; if the value is far from this representative value, the value of an is reduced (multiplied by 0.1) using formula (4)-2. Note that the representative value may be a pixel value at the center of the inlier region 23, or an average value or a median value of pixel values in the inlier region 23.

As described above, in a case where a degree of similarity between a pixel value in the group of images of the respective shooting apparatuses 100 that contribute to determination of a pixel value in a specific region (e.g., the outlier region 22 to be removed as the noise region) and a pixel value in a region (e.g., the inlier region 23 that has an expected pixel value) different from the specific region is equal to or larger than a threshold (the difference therebetween is equal to or smaller than a threshold), the virtual viewpoint image generation parameter an is calculated using formula (4)-3 so that the extent of contribution is large compared to the opposite case. Alternatively, the virtual viewpoint image generation parameter an may be calculated so that the extent of contribution increases as the degree of similarity increases.

Also, in a case where a degree of similarity between a pixel value in the group of images of the respective shooting apparatuses 100 that contribute to determination of a pixel value in a specific region (e.g., the outlier region 22 to be removed as the noise region) and a pixel value in a region (e.g., the inlier region 23 that has an expected pixel value) different from the specific region is lower than a threshold (the difference therebetween exceeds a threshold), the virtual viewpoint image generation parameter an is calculated using formula (4)-2 so that the extent of contribution is small compared to the opposite case. Alternatively, the virtual viewpoint image generation parameter an may be calculated so that the extent of contribution decreases as the degree of similarity decreases.

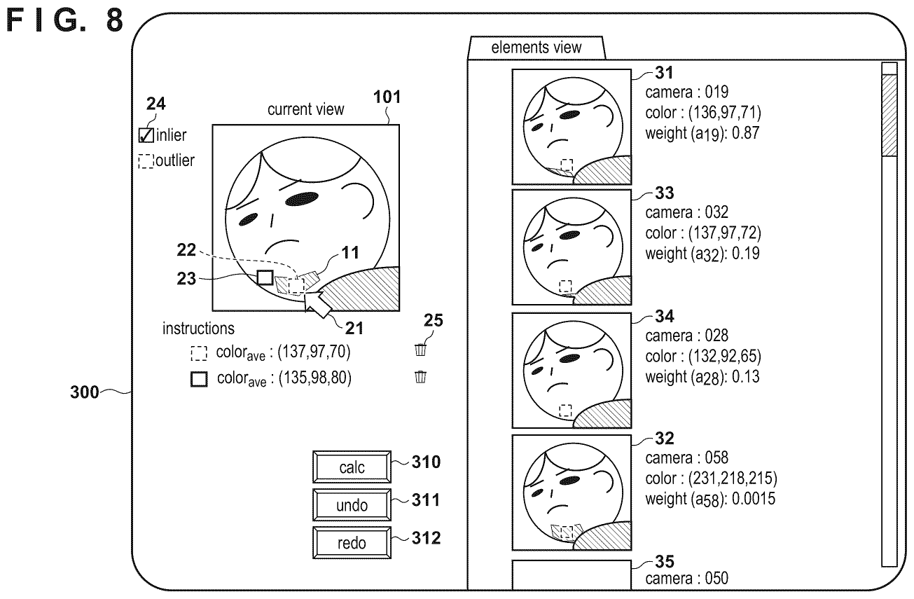

Here, FIG. 8 shows a UI screen displayed after the virtual viewpoint image 101 has been updated according to the case of the present exemplary modification. The coefficients for the images of the cameras 19, 32, and 28 are multiplied by 1.5, and the coefficient for the camera 58 is multiplied by 0.01 (=0.1×0.1) via formulae (2) and (4). As a result, the pixel values in the noise region 22 have been brought close to the pixel values in the inlier region, thereby further alleviating noise. Note that no limitation is intended by these values, and the values can be determined based on empirical values or the like.

As described above, as the inlier region is designated in addition to the outlier region, the cameras for which the virtual viewpoint image generation parameters are to be increased or reduced can be differentiated more clearly, thereby further facilitating the reduction in the influence of noise.

Note that the volumetric data is not limited to the above-described contents, and may be composed of the following elements, for example. That is to say, the volumetric data may be a colored three-dimensional point group, which indicates the three-dimensional shape and colors of the subject 5, and shooting apparatus information. Also, the volumetric data may be configured in the form of a three-dimensional model including both a polygon mesh and a texture image, in place of the three-dimensional point group. Furthermore, in order to perform image-based rendering, the group of images shot by the plurality of shooting apparatuses 100 and shape data of the subject may be configured in the form of a three-dimensional point group that represents only coordinates. For example, a virtual viewpoint image may be generated through image-based rendering based on the pixel values of the group of images of the shooting apparatuses 100 and shape data of the subject 5. In addition, shape data may be in a depth image format with which the distances between the respective shooting apparatuses 100 to the subject 5 are stored on a per-pixel basis as described in Japanese Patent Laid-Open No. 2018-42237.

### Second Embodiment

The present embodiment will be described using an example in which a user operation is further simplified by searching for a peripheral region similar to a region input by the user, and interpolating an input. A description of constituents similar to those of the first embodiment will be omitted.

### <System Configuration and Functional Configuration of Information Processing Apparatus>

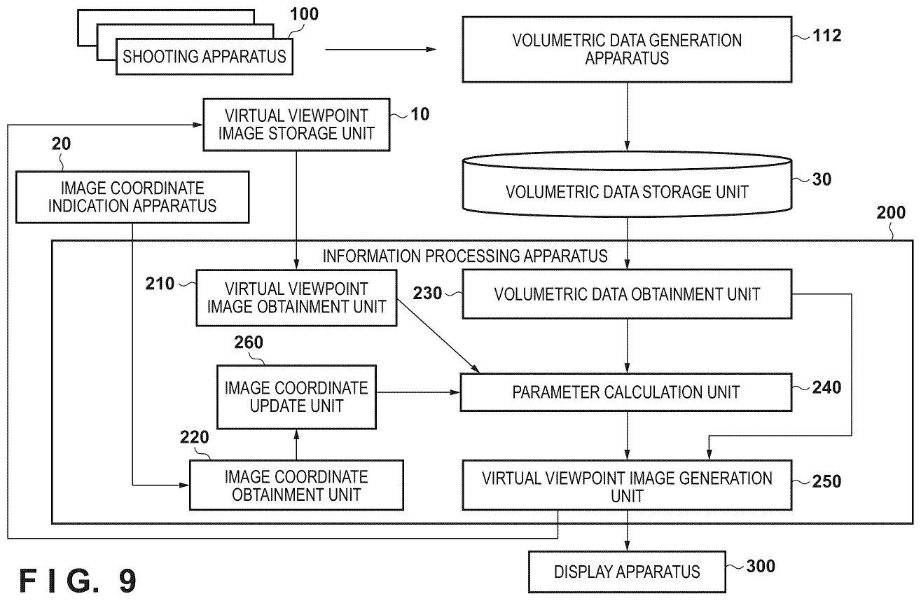

FIG. 9 shows a system configuration diagram according to the present embodiment. In the present embodiment, the information processing apparatus 200 further includes a coordinate update unit 260 in addition to the constituent elements of FIG. 1. Image coordinate data obtained by the image coordinate obtainment unit 220 is transmitted to the image coordinate update unit 260. The image coordinate update unit 260 searches for a similar region around the obtained image coordinates, updates the image coordinate data, and transmits the updated image coordinate data to the parameter calculation unit 240.

### <Processing>

Next, a procedure of processing executed by the information processing apparatus 200 according to the present embodiment will be described with reference to a flowchart of FIG. 10. The processing of FIG. 10 is obtained by adding step S02070 to the processing of FIG. 4.

In step S02070, the image coordinate update unit 260 calculates color differences, similarly to formula (3), with respect to eight neighboring pixels around the image coordinates (x, y); if the color differences are smaller than a threshold, that is to say, if the pixels are similar, they are deemed as a noise region, and neighboring pixels are further searched repeatedly. The search is continued until there is no more similar pixel in neighboring pixels. Alternatively, the search range may be set at 10 px vertically and horizontally in performing the peripheral search.

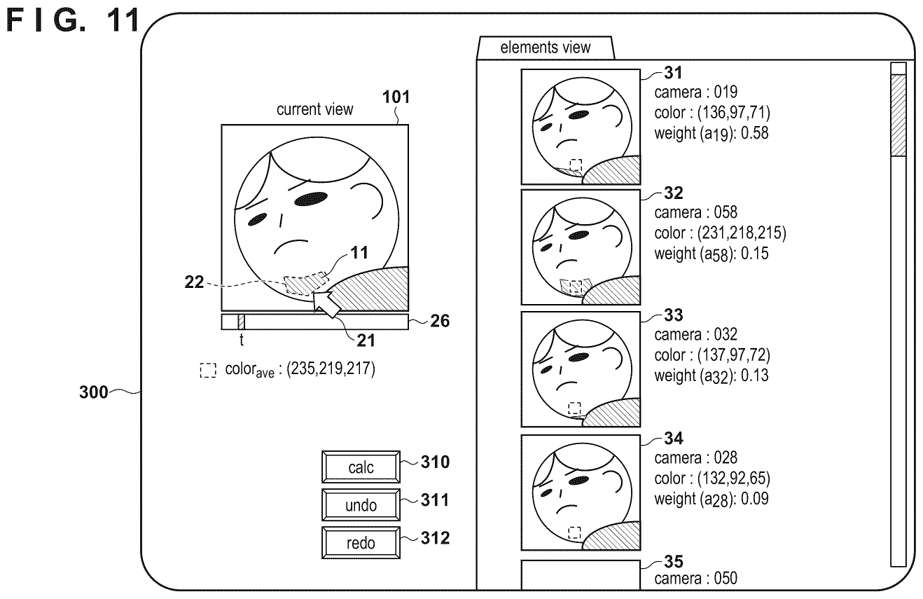

Here, FIG. 11 shows a UI screen displayed on the display apparatus 300 according to the present embodiment. As a result of searching the neighboring pixels, the image coordinates 22 have been updated to include the noise region 11. Furthermore, in a case where the virtual viewpoint image 101 is moving image data that includes time-series frames, the image coordinates (x, y) or pixels neighboring the same may be further searched in a similar manner in a frame t−1 and a frame t+1 that precede and succeed a designated frame t that has been designated using a seek bar 26, and the search may be continued until there is no more similar pixel in a time series as well. In this way, the search may be performed also in the time direction.

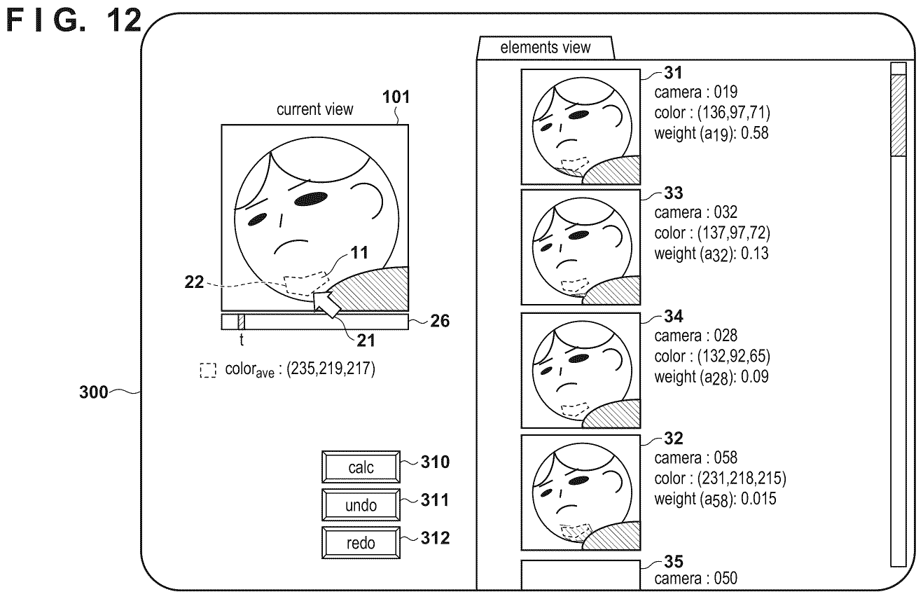

Also, FIG. 12 shows a UI screen displayed on the display apparatus 300 in step S03010 according to the present embodiment. The region 22 indicated by the user in step S02040 has been updated to include the noise region 11. Parameters are calculated in step S02050 with respect to this updated region 22, the virtual viewpoint image 101 is updated in step S02060, and the influence of noise is reduced in the entire noise region 11. Furthermore, although not shown, the influence of noise has been reduced also in the preceding and succeeding frames.

As described above, the processing range is expanded in the image space or in the time direction by interpolating an input through the search around the image coordinates indicated by the user; thus, similar noise regions can be collectively updated without the user indicating the coordinates of noise each time. Therefore, a user operation can be further simplified.

### Third Embodiment

According to the above-described embodiments, the user needs to indicate a region in a virtual viewpoint image. In contrast, the present embodiment will be described using an example in which a noise region is indicated automatically by constructing and using a training model that learns a region indicated by the user with respect to inputting of a virtual viewpoint image. A description of constituents similar to those of the first embodiment will be omitted.

### <System Configuration and Functional Configuration of Information Processing Apparatus>

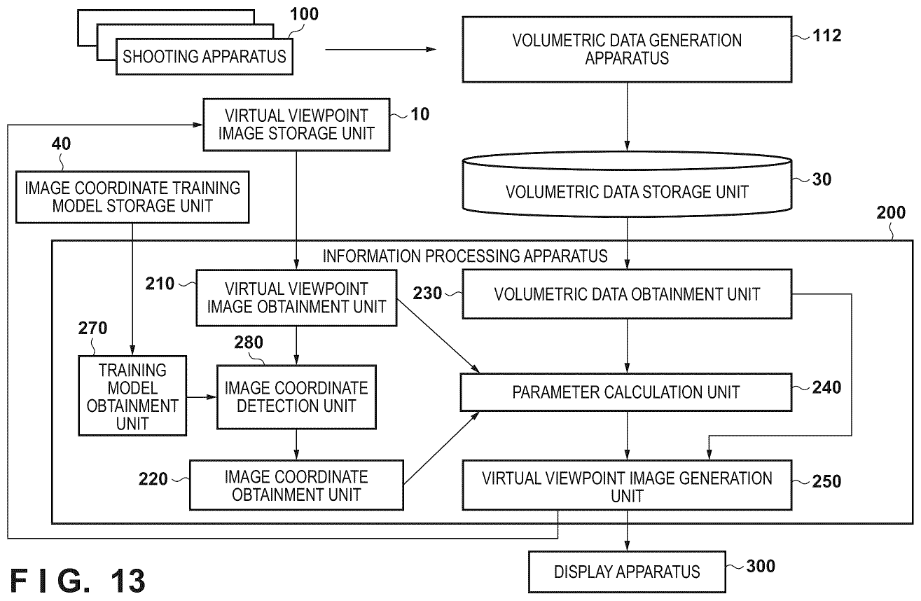

FIG. 13 shows a system configuration diagram according to the present embodiment. The system according to the present embodiment includes an image coordinate training model storage unit 40 in place of the image coordinate indication apparatus 20. Also, the information processing apparatus 200 according to the present embodiment further includes a training model obtainment unit 270 and an image coordinate detection unit 280 in addition to the constituent elements of FIG. 1.

The training model obtainment unit 270 obtains image coordinate training model data from the image coordinate training model storage unit 40. The image coordinate detection unit 280 obtains virtual viewpoint image data from the virtual viewpoint image storage unit 10, and obtains image coordinate training model data from the training model obtainment unit 270. Then, the image coordinate detection unit 280 detects image coordinates through an inference process that uses a training model, and then transmits the detected image coordinate data to the image coordinate obtainment unit 220.

### <Processing>

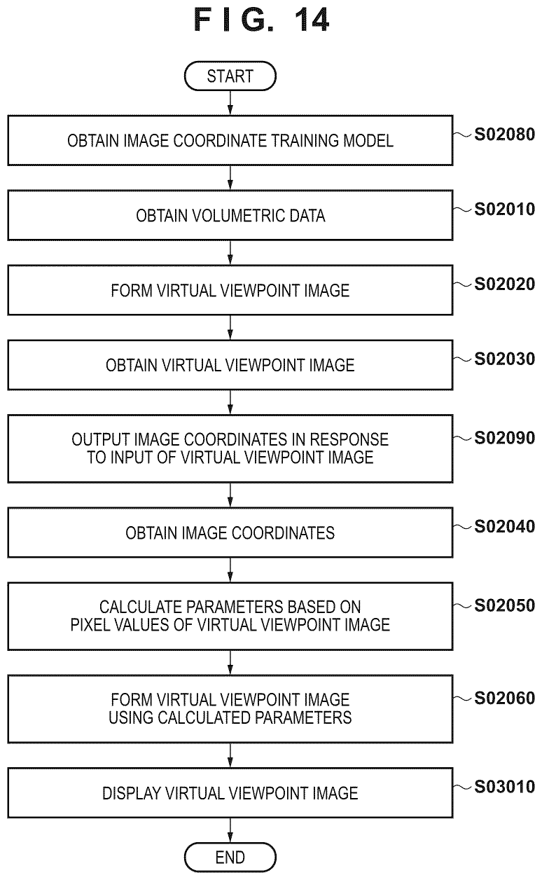

Next, a procedure of processing executed by the information processing apparatus 200 according to the present embodiment will be described with reference to a flowchart of FIG. 14. The processing of FIG. 14 is obtained by adding step S02080 and step S02090 to the processing of FIG. 4.

In step S02080, the training model obtainment unit 270 obtains an image coordinate training model from the image coordinate training model storage unit 40. The image coordinate training model is a neural network which has been implemented using, for example, an open-source machine learning software library, and which has learned a region that has been indicated by the user in the above-described embodiments as supervisory data. In generating the image coordinate training model, a training model generation unit may be separately added that executes training processing using the region indicated by the user in the first embodiment and virtual viewpoint image data as inputs. In the present embodiment, the image coordinate training model is obtained as a data file from an external recording apparatus, and stored into the image coordinate training model storage unit 40.

In step S02090, the image coordinate detection unit 280 obtains the virtual viewpoint image obtained in step S2030 as an input, and outputs an inference result image using the image coordinate training model. The inference result image is, for example a grayscale image that has the same image size as the virtual viewpoint image and has 8 bits per channel, and the value of each pixel therein indicates the probability that the pixel is a noise region using a tone of 0 to 255.

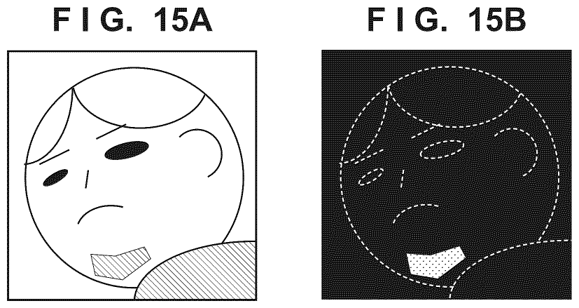

Here, FIG. 15A shows a virtual viewpoint image that has been input, and FIG. 15B shows an inference result image corresponding to this input. Although the outline of the subject 5 is indicated by a dash line for the sake of description, the pixel values of the outline portion is 0 and displayed in black in practice. As the probabilities around a noise region 12 below the chin of the subject 5 have been inferred to be high, the corresponding pixel values are large and displayed in white. Around the outline portion of the noise region 12, the pixel values have a gradient indicating a lower probability toward the outside.

In the subsequent step S02040, the image coordinate obtainment unit 220 obtains the inference result image as image coordinate data. In step S02050, parameters are calculated based on the pixel values in the obtained inference result image. That is to say, with respect to pixels (x, y) in the inference result image that have non-zero pixel values, parameters are calculated based on the following formula (5).

$$[ Math . 5 ]$$

$${a}_{n} ( x , y ) = \{ \begin{matrix}f ( θ , dist ) & if pt ( x , y ) not exists \\ {a}_{n} ⋆ 1 - {I}_{gray} / 255 & else if Δ E ( I , {I}_{n} ) < {th}_{Δ E} \\ {a}_{n} & else if Δ E ( I , {I}_{n} ) < {th}_{Δ E}\end{matrix} \qquad ( 5 )$$

Here, I_{gray} denotes a pixel value in the inference result image; formula (5) is designed to subtract a normalized value obtained by dividing this pixel value by 255 from 1, thereby increasing the extent of update of a virtual viewpoint image generation parameters an as the probability of this pixel value being the noise region increases.

Note that the method of using a pixel value in the inference result image is not limited to this; for example, instead of using this method, image coordinate data may be generated by extracting coordinates in the inference result image that have pixel values larger than a predetermined value, and parameters may be calculated using a method similar to that of the first embodiment.

As described above, a noise region can be indicated automatically by constructing and using a training model that learns a region indicated by the user with respect to inputting of a virtual viewpoint image.

### Other Exemplary Modifications

Although the above embodiments have been described using an example in which a virtual viewpoint image is rendered using a blending technique, no limitation is intended by this. Alternatively, a virtual viewpoint image may be rendered through, for example, model-based rendering. For example, a virtual viewpoint image may be generated by coloring shape data that has been obtained from the volumetric data storage unit 30 as intermediate data, and rendering the colored shape data on a virtual viewpoint.

In this case, it is necessary to generate a colored three-dimensional point group and a texture image by compositing pixel values in the group of images shot by the shooting apparatuses 100 when coloring the shape data. In generating the colors of the three-dimensional point group and the texture image, the influence of noise can be reduced via a noise region indication method and a parameter calculation method similar to those of the first embodiment. Furthermore, in a case where the shape data is in a format where it cannot be used as is in the generation of the texture image, such as a depth image format, a three-dimensional model generation unit that converts the shape data into a polygon mesh may be separately provided. The three-dimensional model generation unit generates a three-dimensional model of the subject 5 based on pixel values in the group of images of the shooting apparatuses 100, the virtual viewpoint image generation parameters, and shape data of the subject 5.

According to the present disclosure, the complexity of the search for an image that causes noise can be reduced, and in addition, a virtual viewpoint image can be generated by effectively using image data outside a noise region.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-122743, filed Jul. 27, 2023, which is hereby incorporated by reference herein in its entirety.

What is claimed is:

1. An information processing apparatus comprising:
one or more memories storing instructions; and
one or more processors executing the instructions to:
obtain a first virtual viewpoint image, wherein the first virtual viewpoint image is generated based on a group of images obtained by shooting a subject from a plurality of directions;
obtain at least one image coordinate in a specific region in the first virtual viewpoint image;
determine, based on a pixel value at the at least one image coordinate, a parameter for generating a virtual viewpoint image; and
generate a second virtual viewpoint image using the determined parameter.

2. The information processing apparatus according to claim 1, wherein
the one or more processors further execute the instructions to:
search for a pixel with a pixel value similar to the pixel value at the at least one image coordinate, and update the image coordinates; and
determine the parameter based on a pixel value at the updated image coordinates.

3. The information processing apparatus according to claim 2, wherein
the one or more processors further execute the instructions to search pixels around a pixel at the at least one image coordinate.

4. The information processing apparatus according to claim 2, wherein
the one or more processors further execute the instructions to search pixels in frames that precede and succeed the first virtual viewpoint image.

5. The information processing apparatus according to claim 1, wherein
the one or more processors further execute the instructions to:
obtain a training model that outputs image coordinates in the specific region with respect to inputting of the first virtual viewpoint image;
output the image coordinates in the specific region based on the training model; and
obtain the output image coordinates.

6. The information processing apparatus according to claim 5, wherein
the one or more processors further execute the instructions to:
generate a training model that outputs image coordinates in the specific region with respect to inputting of the first virtual viewpoint image; and
obtain the generated training model.

7. The information processing apparatus according to claim 1, wherein
the one or more processors further execute the instructions to, in a case where a degree of similarity between a pixel value in the specific region and a pixel value in the group of images that contributes to determination of the pixel value in the specific region is equal to or higher than a threshold, determine the parameter so that an extent of contribution is small compared to a case where the degree of similarity is lower than the threshold.

8. The information processing apparatus according to claim 1, wherein
the one or more processors further execute the instructions to, in a case where a degree of similarity between a pixel value in the group of images that contributes to determination of a pixel value in the specific region and a pixel value in a region different from the specific region is equal to or higher than a threshold, determine the parameter so that an extent of contribution is large compared to a case where degree of similarity is lower than the threshold.

9. The information processing apparatus according to claim 1, wherein
the one or more processors further execute the instructions to generate the second virtual viewpoint image based on pixel values in the group of images and shape data of the subject through image-based rendering.

10. The information processing apparatus according to claim 1, wherein
the one or more processors further execute the instructions to:
generate a three-dimensional model of the subject based on pixel values in the group of images, the parameter, and shape data of the subject; and
generate the second virtual viewpoint image using the three-dimensional model through model-based rendering.

11. The information processing apparatus according to claim 1, wherein
the one or more processors further execute the instructions to obtain the at least one image coordinate based on inputting performed on an indication apparatus that accepts an indication for designating image coordinates in the first virtual viewpoint image.

12. The information processing apparatus according to claim 11, wherein
the image coordinates in the first virtual viewpoint image are designated as a quadrilateral region.

13. The information processing apparatus according to claim 1, wherein
the specific region is a noise region that appears in the first virtual viewpoint image.

14. A control method for an information processing apparatus, comprising:
obtaining a first virtual viewpoint image, wherein the first virtual viewpoint image is generated based on a group of images obtained by shooting a subject from a plurality of directions;
obtaining at least one image coordinate in a specific region in the first virtual viewpoint image;
determining, based on a pixel value at the at least one image coordinate, a parameter for generating a virtual viewpoint image; and
generating a second virtual viewpoint image using the determined parameter.

15. A non-transitory computer-readable storage medium storing a program for causing a computer to execute a control method for an information processing apparatus, the control method comprising:
obtaining a first virtual viewpoint image, wherein the first virtual viewpoint image is generated based on a group of images obtained by shooting a subject from a plurality of directions;
obtaining at least one image coordinate in a specific region in the first virtual viewpoint image;
determining, based on a pixel value at the at least one image coordinate, a parameter for generating a virtual viewpoint image; and
generating a second virtual viewpoint image using the determined parameter.
